(19) United States
(12) Patent Application Publication
(10) Pub. No.: US 2023/0077782 A1
(43) Pub. Date: Mar. 16, 2023

(54) APPROACHES TO MODIFYING A COLOR OF AN ELECTROCHROMIC STACK IN A TINTED STATE

(71) Applicant: SAGE Electrochromics, Inc., Faribault, MN (US)

(72) Inventors: Wen Li, Lakeville, MN (US); Nicolas Antoine Mercadier, Minneapolis, MN (US); Jean-Christophe Giron, Edina, MN (US); Hannah Leung Ray, Minneapolis, MN (US); Xiaoguang Hao, Belmont, NC (US); Theo Chevallier, Paris (FR); Chloe Bouard, Auberviliers (FR); Samuel Emile Dubrenat, Paris (FR)

(73) Assignee: SAGE Electrochromics, Inc., Faribault, MN (US)

(21) Appl. No.: 18/050,933

(22) Filed: Oct. 28, 2022

Related U.S. Application Data
(62) Division of application No. 17/182,874, filed on Feb. 23, 2021.
(60) Provisional application No. 62/981,427, filed on Feb. 25, 2020.

(51) Int. Cl. C23C 14/00; G02F 1/1523; C23C 14/08; C23C 14/54; C23C 14/34; G02F 1/1524; C23C 14/14; H01J 37/34

(52) U.S. Cl. CPC C23C 14/0015; G02F 1/1525; C23C 14/083; C23C 14/548; C23C 14/3464; C23C 14/541; C23C 14/3492; C23C 14/542; G02F 1/1524; C23C 14/14; C23C 14/3414; H01J 37/3429; G02F 2001/1555

(57) ABSTRACT

The color of an electrochromic stack in a tinted state may be modified to achieve a desired color target by utilizing various techniques alone or in combination. A first approach generally involves changing a coloration efficiency of a WOₓ electrochromic (EC) layer by lowering a sputter temperature to achieve a WOₓ microstructural change in the EC layer. A second approach generally involves utilizing a dopant (e.g., Mo, Nb, or V) to improve the neutrality of the tinted state of WOₓ (coloration efficiency changes). A third approach generally involves tailoring a thickness of the WOₓ layer to tune the color of the tinted stack.

This application is a divisional of U.S. patent application Ser. No. 17/182,874, filed Feb. 23, 2021, which claims benefit of priority to U.S. Provisional Application Ser. No. 62/981,427, filed Feb. 25, 2020, entitled “APPROACHES TO MODIFYING A COLOR OF AN ELECTROCHROMIC STACK IN A TINTED STATE”, which are incorporated herein by reference in their entirety.

### FIELD OF THE DISCLOSURE

The present disclosure is directed to electrochromic devices, and more specifically to various approaches to modifying a color of an electrochromic stack in a tinted state.

### BACKGROUND

An electrochromic device helps to block the transmission of visible light and keep a room of a building or passenger compartment of a vehicle from becoming too warm. The color of electrochromic glazing is usually blue in a dark state. For some applications, it may be advantageous or otherwise desirable (e.g., for aesthetic purposes) for an electrochromic stack to have a more neutral color than blue in the dark state. Additionally, the typical blue color in the dark state may have a negative impact on lighting within a space by distorting colors for someone in the space, representing another potential advantage of a more neutral color. The color of the electrochromic stack cannot be easily modified because it is linked to the fundamental properties of the materials. Further improvement of window designs is desired.

### BRIEF DESCRIPTION OF THE DRAWINGS

FIG. 1 is a diagram depicting a process of forming an electrochromic stack having a more neutral color in a dark state using various approaches to forming an electrochromic (EC) layer, according to some embodiments.

FIG. 2 is a graph depicting experimental data related to a first approach to forming the EC layer which generally involves modifying a substrate temperature during formation of a WOₓ EC layer of the electrochromic stack, according to some embodiments.

FIG. 3 is a graph depicting three scanning electron microscope (SEM) images showing three different WOₓ microstructures associated with three different substrate temperatures during sputtering of the WOₓ EC layer of the electrochromic stack, according to some embodiments.

FIGS. 4 to 8 are graphs depicted experimental data related to a second approach to forming the EC layer which generally involves utilizing a mixed M:W target (where M=Nb, Mo, or V) to introduce dopant(s) into a sputter-deposited EC layer of the electrochromic stack, according to some embodiments.

FIGS. 9 and 10 are graphs depicting experimental data associated with a third approach to forming the EC layer of the electrochromic stack, which generally involves adjusting a thickness of a sputter-deposited WOₓ EC layer by reducing a number of sputter targets, according to some embodiments.

Skilled artisans appreciate that elements in the figures are illustrated for simplicity and clarity and have not necessarily been drawn to scale. For example, the dimensions of some of the elements of the figures may be exaggerated relative to other elements to help to improve understanding of embodiments of the invention.

### DETAILED DESCRIPTION

The present disclosure describes various methods to produce an electrochromic stack with a more neutral (e.g., more grey and less blue) in a tinted state. The fundamental principle is to change the coloration efficiency of the EC layer (WOₓ) to closer to the CE layer. The invention includes three different approaches to achieve grey color. The first approach generally involves adjusting the substrate temperature to change the micro-structure of a sputter-deposited WOₓ EC layer. The second approach generally involves utilizing a mixed metallic M:W target to introduce dopant(s) into the sputter-deposited WOₓ EC layer. The third approach generally involves adjusting the thickness of the sputter-deposited WOₓ EC layer by reducing a number of sputter targets.

As used herein, the coloration efficiency of an electrode of an electrochromic stack refers to the variation in luminous absorption of an ITO/electrode stack obtained when the charge of the electrode is varied by 1 mC/cm². The coloration efficiency is defined as a function of the wavelength, with the coloration efficiency described herein corresponding to a weighted average over the visible range, calculated similarly to the relative luminance Yin the International Commission on Illumination (CIE) 1931 standard.

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the term “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. The description should be read to include one or at least one and the singular also includes the plural, or vice versa, unless it is clear that it is meant otherwise.

The use of the word “about”, “approximately”, or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the glass, vapor deposition, and electrochromic arts.

The embodiments as illustrated in the figures and described below help in understanding particular applications for implementing the concepts as described herein. The embodiments are exemplary and not intended to limit the scope of the appended claims.

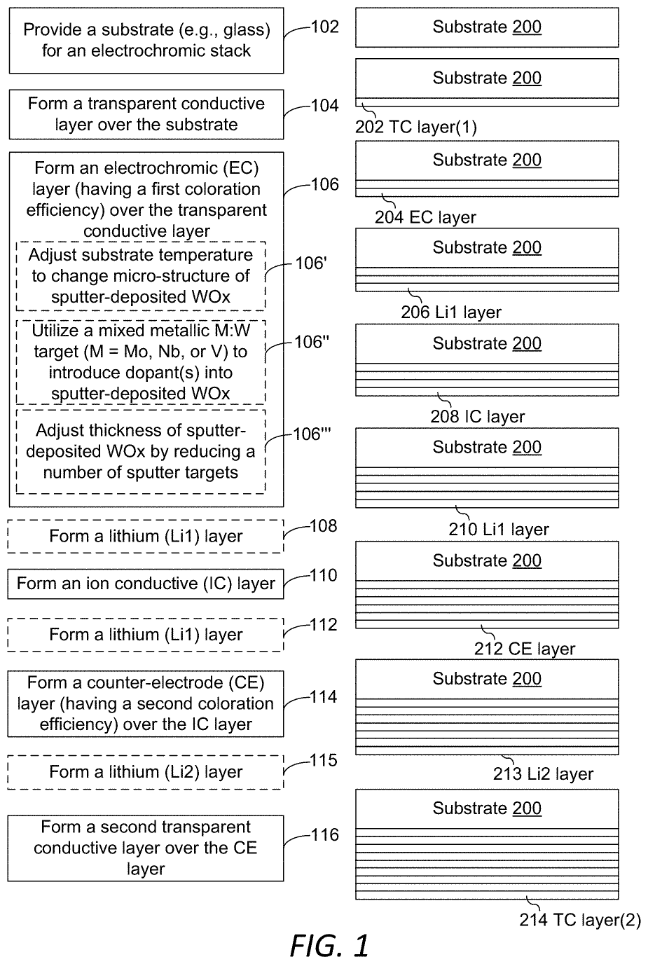

FIG. 1 depicts a process of forming an electrochromic stack having a more neutral color in a dark state using various approaches to forming an electrochromic (EC) layer, according to some embodiments. The left side of FIG. 1 is a flow diagram depicting process stages in the formation of an electrochromic stack, and the right side of FIG. 1 is a block diagram depicting a simplified cross-sectional view of the different layers that are formed during each stage of the process of forming the electrochromic stack.

At 102, the process includes providing a substrate for an electrochromic stack. The substrate is identified by the reference character 200 in the block diagram on the right side of FIG. 1. The substrate 200 may include a glass substrate, a sapphire substrate, an aluminum oxynitride (AlON) substrate, a spinnel substrate, or a transparent polymer. In a particular embodiment, the substrate 200 can include ultra-thin glass that is a mineral glass having a thickness in a range of 50 microns to 300 microns. The transparent polymer can include a polyacrylate, a polyester, a polycarbonate, a polysiloxane, a polyether, a polyvinyl compound, another suitable class of transparent polymer, or a mixture thereof. In another embodiment, the substrate 200 can be a laminate including layers of the materials that make up the previously described transparent substrates. In another embodiment, the laminate can include a solar control layer that reflects ultraviolet radiation or a low emissivity material. The substrate 200 may or may not be flexible.

In an embodiment, the substrate 200 can be a glass substrate that can be a mineral glass including SiO₂ and one or more other oxides. Such other oxides can include Al₂O₃, an oxide of an alkali metal, an oxide of an alkaline earth metal, such as B₂O₃, ZrO₂, P₂O₅, ZnO, SnO₂, SO₃, As₂O₂, or Sb₂O₃. The substrate 200 may include a colorant, such as oxides of iron, vanadium, titanium, chromium, manganese, cobalt, nickel, copper, cerium, neodymium, praseodymium, or erbium, or a metal colloid, such as copper, silver, or gold, or those in an elementary or ionic form, such as selenium or sulfur.

In an embodiment in which the substrate 200 is a glass substrate, the glass substrate is at least 50 wt % SiO₂. In an embodiment, the SiO₂ content is in a range of 50 wt % to 85 wt %. Al₂O₃ may help with scratch resistance, for example, when the major surface is along an exposed surface of the laminate being formed. When present, Al₂O₃ content can be in a range of 1 wt % to 20 wt %. B₂O₃ can be usefully used to reduce both the viscosity of the glass and its thermal expansion coefficient. The B₂O₃ content may be no greater than 20 wt %, and in a particular embodiment, less than 15 wt %. Alkaline earth metals include magnesium, calcium, strontium, and barium. The oxides of an alkaline earth metal are useful for reducing the viscosity of the glass and facilitating fusion, without heavily penalizing the expansion coefficient. Calcium and magnesium have a relatively low impact on the density of the glass as compared to some of the other oxides. The total content of alkaline metal oxide may be no greater than 25 wt %, 20 wt %, or 15 wt %. Oxides of an alkali metal can reduce viscosity of the glass substrate and its propensity to devitrify. The total content of alkali metal oxides may be at most 8 wt %, 5 wt %, or 1 wt %. In some applications, the glass substrate is desired to be clear, and thus, the content of colorants is low. In a particular embodiment, the iron content is less than 200 ppm.

The glass substrate can include heat-strengthened glass, tempered glass, partially heat-strengthened or tempered glass, or annealed glass. “Heat-strengthened glass” and “tempered glass”, as those terms are known in the art, are both types of glass that have been heat treated to induce surface compression and to otherwise strengthen the glass. Heat-treated glass is classified as either fully tempered or heat-strengthened. In an embodiment, the glass substrate is tempered glass and has a surface compression of about 69 MPa or more and an edge compression of about 67 MPa or more. In another embodiment, the transparent substrate is heat-strengthened and has a surface compression in a range of 24 MPa to 69 MPa and an edge compression between 38 MPa and 67 MPa. The “annealed glass” means glass produced without internal strain imparted by heat treatment and subsequent rapid cooling. Thus annealed glass only excludes heat-strengthened glass or tempered glass. The glass substrate can be laser cut.

At 104, the process includes forming a transparent conductive layer over the substrate. The transparent conductive layer (“TC layer(1)”) is identified by the reference character 202 in the block diagram on the right side of FIG. 1. As shown on the right side of FIG. 1, the transparent conductive layer 202 overlies the substrate 200. The transparent conductive layer 202 can include doped metal oxide. The doped metal oxide can include a zinc oxide or a tin oxide, either of which may be doped with a Group 3 element, such as Al, Ga, or In. Indium tin oxide (ITO) and aluminum zinc oxide (AZO) are exemplary, non-limiting materials that can be used. In another embodiment, the transparent conductive layer 202 can be either a polyaniline, polypyrrole, a polythiophene (e.g., poly(3,4-ethylenedioxythiophene) (PDOT), another suitable conductive organic polymer, or any combination thereof. If needed or desired, the organic compound may be sulfonated.

At 106, the process includes forming an EC layer (having a first coloration efficiency) overlying the transparent conductive layer. The EC layer is identified by the reference character 204 in the block diagram on the right side of FIG. 1. In some embodiments, the EC layer may be formed over the substrate according to one or more process parameters to achieve a color target in a dark state of a final EC stack that includes the EC layer. Forming an EC layer may include performing a deposition process using a deposition material to form the EC layer. The process parameters according to which the EC layer may be formed may specify a composition of the deposition material to achieve the color target or may specify one or more deposition process parameters to achieve the color target, according to some embodiments.

As further described herein, the EC layer 204 may be formed according to a first approach (identified by reference character 106′ in FIG. 1), a second approach (identified by reference character 106″ in FIG. 1), a third approach (identified by reference character 106′″ in FIG. 1), or various combinations thereof. As illustrated in FIG. 1, the first approach generally involves adjusting a substrate temperature to change a micro-structure of a sputter-deposited WOₓ EC layer. The second approach generally involves utilizing a mixed metallic M:W target (where M=Mo, Nb, or V) to introduce a dopant (or dopants) into the sputter-deposited WOₓ EC layer. The third approach generally involves adjusting a thickness of a sputter-deposited WOₓ EC layer by reducing a number of sputter targets. In some embodiments, the formation of the EC layer 204 may include a combination of selected elements of the individual approaches. As an illustrative, non-limiting example, adjusting the substrate temperature (as in the first approach) when utilizing a mixed metallic M:W target (as in the second approach) to form the EC layer 204 may result in different performance characteristics in an electrochromic stack that includes such an EC layer. It will be appreciated that different combinations of substrate temperatures, dopant concentrations, and layer thicknesses may each result in the formation of an EC layer that affects the overall performance characteristics in an electrochromic stack.

FIG. 1 illustrates that, in some embodiments, the process may include forming a lithium layer (also referred to herein as a “Li1 layer”) overlying the EC layer, at 108. The (optional) Li1 layer is identified by the reference character 206 in the block diagram on the right side of FIG. 1. In some embodiments, the Li1 layer may be a sputter-deposited metallic lithium layer. The amount of lithium deposited on the EC layer may vary and, in some embodiments, may be adjusted to achieve desired performance characteristics in a particular electrochromic stack design.

At 110, the process includes forming an ion conductive (IC) layer overlying the EC layer (containing the optional overlying Li1 layer). The IC layer is identified by the reference character 208 in the block diagram on the right side of FIG. 1. FIG. 1 illustrates that, in some embodiments, the process may include forming a lithium layer (also referred to herein as a “Li1 layer”) overlying the IC layer, at 112. The (optional) Li1 layer is identified by the reference character 210 in the block diagram on the right side of FIG. 1. In some embodiments, the Li1 layer may be a sputter-deposited metallic lithium layer. The amount of lithium deposited on the IC layer may vary and, in some embodiments, may be adjusted to achieve desired performance characteristics in a particular electrochromic stack design.

At 114, the process includes forming a counter-electrode (CE) layer (having a second coloration efficiency) overlying the IC layer (containing the optional overlying Li1 layer). The CE layer is identified by the reference character 212 in the block diagram on the right side of FIG. 1. As described further herein, in some embodiments, the relative thicknesses of the EC and CE layers may be adjusted to achieve desired performance characteristics in a particular electrochromic stack design.

FIG. 1 illustrates that, in some embodiments, the process may include forming a lithium layer (also referred to herein as a “Li2 layer”) overlying the CE layer, at 115. The (optional) Li2 layer is identified by the reference character 213 in the block diagram on the right side of FIG. 1. In some embodiments, the Li2 layer may be a sputter-deposited metallic lithium layer. The amount of lithium deposited on the CE layer may vary and, in some embodiments, may be adjusted to achieve desired performance characteristics in a particular electrochromic stack design.

At 116, the process includes forming a second transparent conductive layer overlying the CE layer. The transparent conductive layer (“TC layer(2)”) is identified by the reference character 214 in the block diagram on the right side of FIG. 1. As with the transparent conductive layer 202 overlying the substrate 200, the transparent conductive layer 214 overlying the CE layer 212 (containing the optional Li2 layer) can include doped metal oxide. The doped metal oxide can include a zinc oxide or a tin oxide, either of which may be doped with a Group 3 element, such as Al, Ga, or In, with ITO and AZO being exemplary, non-limiting materials that can be used. In another embodiment, the transparent conductive layer 214 can be either a polyaniline, polypyrrole, a polythiophene (e.g., PDOT), another suitable conductive organic polymer, or any combination thereof. If needed or desired, the organic compound may be sulfonated.

The EC layer 204 can have a variable transmission of visible light and near infrared radiation (e.g., electromagnetic radiation having wavelengths in a range of 700 nm to 2500 nm) depending on the biasing conditions. For example, in the absence of an electrical field, the electrochromic device is in a high transmission (“bleached”) state, and in the presence of an electrical field, mobile ions, such as Li⁺, Na⁺, or H⁺, can migrate from the CE layer 212, through the IC layer 208 to the EC layer 204 and reduce the transmission of visible light and near infrared radiation through the electrochromic device. The lower transmission state may also be referred to as a tinted or colored state.

The CE layer 212 can provide a principal source of mobile ions. Furthermore, the CE layer 212 remains substantially transparent to visible light when the electrochromic device is in its high transmission state. The CE layer 212 can include an oxide of transition metal element. In an example embodiment, the CE layer 212 can include an oxide of nickel. The nickel may be in its divalent state (Ni²⁺), its trivalent state (Ni³⁺), or a combination thereof. The CE layer 212 can include an oxide of a transition metal element, such as such as iridium, rhodium, ruthenium, tungsten, manganese, cobalt, or the like. The CE layer 212 can also provide mobile ions that can pass through the IC layer 208. The mobile ions may be incorporated into the CE layer 212 as it is formed. In a finished device, the CE layer 212 may be represented by a chemical formula of:

AₓN²⁺_{(1-y)}Ni³⁺_{y}M_{z}Oₐ,
where:
A is an element that produces a mobile ion, such as Li, Na, or H;
M is a metal; and

0<x≤10,0≤y≤1,0≤z≤10, and (0.5x+1+0.5y+z)≤a≤(0.5x+1+0.5y+3.5z).

In a particular non-limiting embodiment, A is Li, M is W, and, in a finished device, the CE layer may be represented by a chemical formula of:

LiₓNi²⁺_{(1-y)}Ni³⁺_{y}W_{z}O_{(1+0.5x+0.5y+3z)}.
where 1.5≤x≤3, 0.4≤y≤0.95, and 0.15≤z≤1.

The IC layer 208 includes a solid electrolyte that allows ions to migrate through the IC layer 208 as an electrical field across the electrolyte layer is changed from the high transmission state to the low transmission state, or vice versa. In an embodiment, the IC layer 208 can be a ceramic electrolyte. In another embodiment, the IC layer 208 can include a silicate-based or borate-based material. The IC layer 208 may include a silicate, an aluminum silicate, an aluminum borate, a borate, a zirconium silicate, a niobate, a borosilicate, a phosphosilicate, a nitride, an aluminum fluoride, or another suitable ceramic material. Other suitable ion-conducting materials can be used, such as tantalum pentoxide or a garnet or perovskite material based on a lanthanide-transition metal oxide. In another embodiment, as formed, the IC layer 208 may include mobile ions. Thus, lithium-doped or lithium-containing compounds of any of the foregoing may be used. Alternatively, a separate lithiation operation, such as sputtering lithium, may be performed. The IC layer 208 may include a plurality of layers having alternating or differing materials, including reaction products between at least one pair of neighboring layers. In a further embodiment, the refractive index and thickness of the IC layer 208 are selected to have acceptable visible light transmission while keeping electronic current very low. In another embodiment, the IC layer 208 has low or no significant electronic conductivity (e.g., low leakage current).

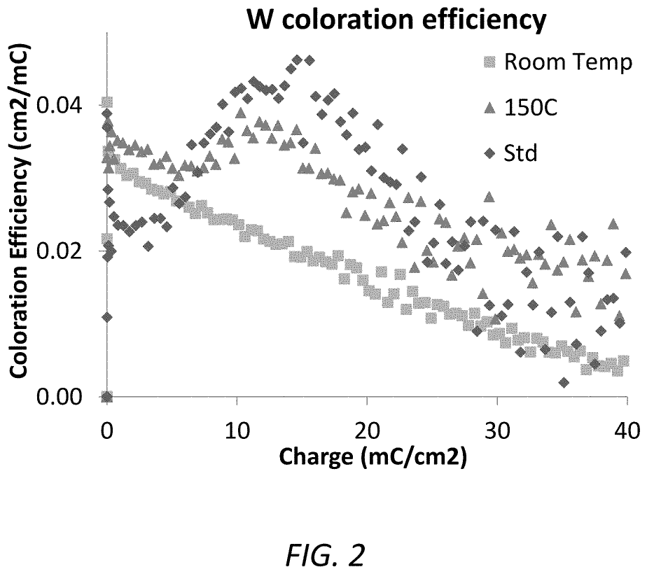

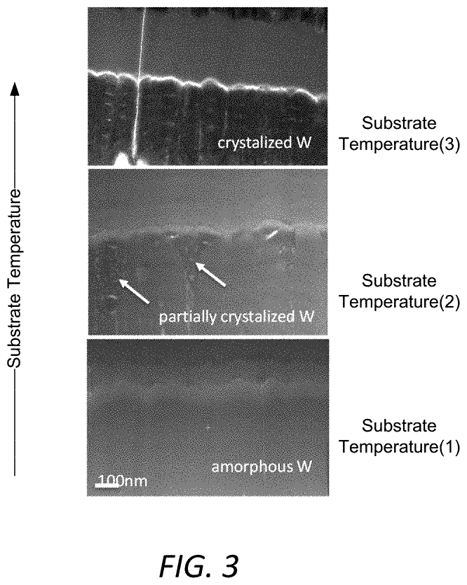

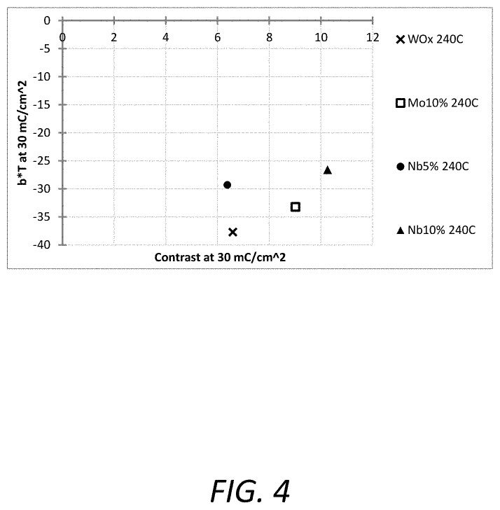

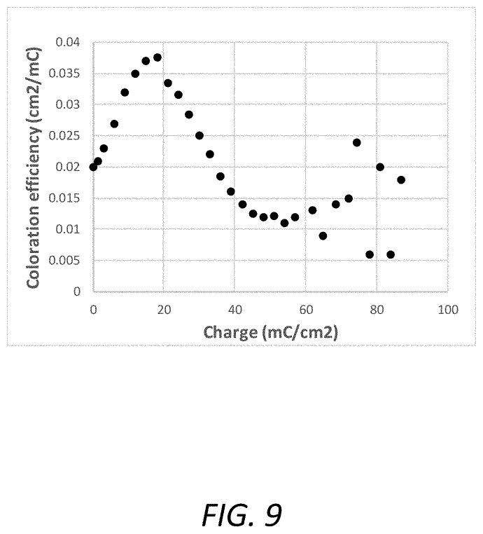

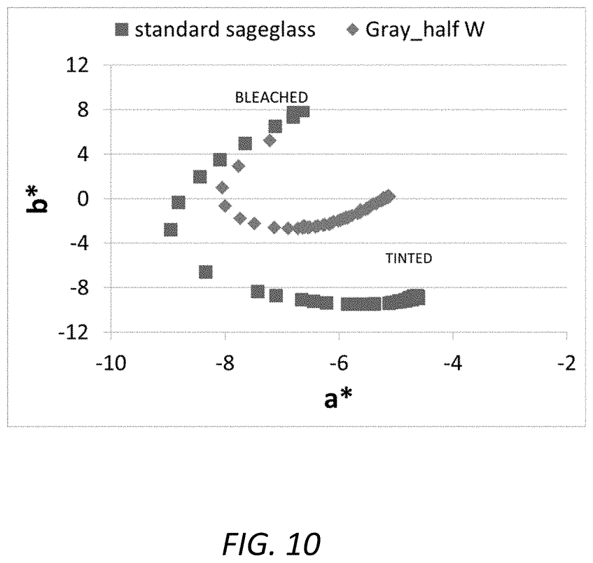

Thus, FIG. 1 illustrates a process of achieving a more neutral color in the dark state according to three approaches of the present disclosure. The following figures provide further details regarding each of the three general approaches to forming the EC layer depicted in FIG. 1. Additional details regarding the first approach (identified by the reference character 106′ in FIG. 1), which generally involves adjusting the substrate temperature to change the micro-structure of the sputter-deposited WOₓ EC layer, are illustrated and described further herein with respect to the embodiments depicted in FIGS. 2 and 3. Additional details regarding the second approach (identified by the reference character 106″ in FIG. 1), which generally involves utilizing a mixed metallic M:W target to introduce dopant(s) into the sputter-deposited WOₓ EC layer, are illustrated and described further herein with respect to the embodiments depicted in FIG. 4 to FIG. 8. Additional details regarding the third approach (identified by the reference character 106′ in FIG. 1), which generally involves adjusting the thickness of the sputter-deposited WOₓ EC layer by reducing a number of sputter targets, are illustrated and described further herein with respect to the embodiments depicted in FIGS. 9 and 10.

In the following figures, FIGS. 2 and 4-9 show the properties of ITO (˜400 nm) and WOₓ (˜400 nm) stacks (also referred to herein as “half-stacks”). FIGS. 3 and 10 show the properties of full stacks, with full stacks being ITO/WOₓ+Li/IC/CE+Li/ITO stacks as defined in FIG. 1. For half stacks, a charge of 30 mC/cm² means that 30 mC/cm² of mobile Lithium are inserted into the electrode.

Overall, grey colored full stacks are obtained by combining two effects. First, the lithiated WOₓ layer in those stacks is less blue than in the “reference stack” as illustrated on the Y-axis in FIGS. 4 to 8. Second, each Li ion colors the WOₓ less efficiently than in the “reference stack.” When one Li ion moves from the CE to the WO_{K}, the CE colors in “yellow” and the WOₓ in “blue.” If the WOₓ has a higher coloration efficiency than the CE, the color of the WOₓ prevails, and the full stack ends up being blue. If both the WOₓ and the CE have similar coloration efficiencies, the full stack ends up being grey. In a conventional “reference stack”, the NiWOₓ CE has a coloration efficiency of 0.02 mC/cm². Bringing the average coloration efficiency of the WOx layer closer to that value makes the stack more grey.

Referring to FIG. 2, a graph depicts selected experimental data associated with an EC layer that is formed according to various approaches in order to achieve a color target, such as a more neutral color in a dark state, according to some embodiments.

As described further herein, “cold” deposition (e.g., at room temperature) of the WOx EC layer leads to an amorphous WOx microstructure and a grey color. Further, “warm” deposition (e.g., at an intermediate temperature) leads to a partially crystallized structure. One advantage associated with deposition at such reduced temperatures is that manufacturing costs may potentially be reduced compared to WOX deposited at higher temperatures. The implementations disclosed herein may result in: (1) an electrochromic stack/device with at least partially amorphous WOx and a grey color; and (2) an electrochromic stack/device with cold-deposited WOx and a grey color.

Referring to FIG. 2, a graph depicts experimental data related to the first approach to achieve a color target by specifying one or more deposition process parameters which generally involves modifying the substrate temperature during formation of the WOx EC layer of the electrochromic stack. The graph depicts coloration efficiency (Y-axis) versus charge (X-axis) for three different experimental temperatures. In the graph, squares represent data associated with a first substrate temperature (room temperature), triangles represent data associated with a second substrate temperature (150° C.), and diamonds represent data associated with a third substrate temperature (280° C.). The third substrate temperature corresponds to a standard (“Std” in FIG. 2) substrate temperature, thereby providing reference data to illustrate the impact on coloration efficiency of a WOₓ EC layer that is sputter-deposited onto a lower temperature substrate.

According to the first approach of reduced-temperature sputtering of the WOₓ EC layer, a deposition process parameter related to the substrate temperature may be specified. For instance, the substrate temperature range may be less than 200° C. (compared to a “standard” process in which the sputtering temperature is greater than 200° C., such as about 240° C. or about 280° C.). The inventors have observed that a conventional deposition process involving sputtering onto a substrate that is heated to a temperature that is greater than 200° C. (also referred to herein as a “high-temperature substrate” or “hot substrate”) results in the formation of a “fully crystallized” WOₓ microstructure. The inventors have also observed that a process involving sputtering onto a substrate at a substantially reduced temperature (also referred to herein as a “room temperature substrate” or “cold substrate”) results in the formation of a “fully amorphous” WOₓ microstructure. The inventors have discovered that heating a substrate to a moderate temperature (also referred to herein as a “moderate-temperature substrate” or “warm substrate”) during sputtering may result in changes to the WOₓ microstructure.

The inventors have discovered that by finely tuning the substrate temperature within a threshold temperature range during sputtering, the WOₓ micro-structure can be changed from the “fully amorphous” WOₓ microstructure to a “partially crystallized in amorphous matrix” WOₓ microstructure. The inventors have discovered that such changes to the WOₓ microstructure may lead to a changed color in the dark state. For example, compared to the color associated with a “fully crystalline” WOₓ microstructure in the dark state, the color in the dark state may appear more neutral and less blue. The threshold temperature range may correspond to a temperature range of 100° C. to 200° C., such as a range of 150° C. to 200° C., a range of 155° C. to 195° C., or a range of 160° C. to 190° C. In addition to the changed color in the dark state, the reduced substrate temperature may provide additional advantages in some cases, such as the potential for reduced substrate heating costs and/or the potential simplification of the design of process equipment.

To illustrate, FIG. 3 depicts three scanning electron microscope (SEM) images showing three different WOₓ microstructures associated with three different substrate temperatures during sputtering. The top image in FIG. 3 illustrates an example of a “fully crystallized” WOₓ microstructure associated with a substrate temperature that is greater than a high temperature threshold, and the bottom image in FIG. 3 illustrates an example of a “fully amorphous” WOₓ microstructure associated with a substrate temperature that is less than a low temperature threshold. The middle image in FIG. 3 illustrates an example of a changed WOₓ microstructure associated with a substrate temperature that is less than the high temperature threshold and that is greater than the low temperature threshold.

In the first approach, a process of forming an electrochromic stack having a more neutral color may include depositing a transparent conductive layer, then sputtering the EC layer at fine-tuned temperature(s), followed by the (optional) sputtering of Li onto the EC layer to form a Li1 layer, then formation of an overlying IC layer (as depicted in the example of FIG. 1). Subsequently, the process of forming additional layers of the EC stack may include the (optional) lithiation of the IC layer to form a Li1 layer, then forming a CE layer overlying the IC layer, followed by the (optional) sputtering of Li onto the CE layer to form a Li2 layer, followed by the formation of a second transparent conductive layer (as depicted in the example of FIG. 1). In some cases, the operating voltage for an EC stack having such a reduced-temperature-sputtered WOₓ EC layer may be higher compared to a similar EC stack having a standard high-temperature-sputtered fully crystalline WOₓ EC layer.

Thus, the first approach involves changing the substrate temperature during sputtering to change the micro-structure of the WOₓ EC layer and to tune a coloration efficiency curve, which results in a final color change of the EC stack in the dark state (i.e., to a desired color target). FIG. 2 depicts the effect of such reduced-temperature sputtering on an associated coloration efficiency curve for two examples of reduced sputtering temperatures, as compared to a standard process involving higher-temperature sputtering to form the WOₓ EC layer. It will be appreciated that the example temperatures depicted in FIG. 2 are for illustrative purposes only and that alternative substrate temperatures may be utilized to “tune” the coloration efficiency of an associated EC stack by changing the micro-structure of the sputter-deposited WOₓ EC layer. The equipment that is utilized for depositing the WOₓ EC layer may include a substrate heater that is adjustable to control a temperature of a substrate (see e.g., the substrate 200 including the first TC layer 202 depicted in FIG. 1) upon which the WOₓ EC layer is deposited (e.g., using a W sputtering target). Thus, in the “room temperature” example depicted in FIG. 2, such a substrate heater may apply no heat to the substrate, representing a “cold” sputtering temperature. Alternatively, in the case of a “warm” sputtering temperature, the substrate heater may be adjusted for reduced heating of the substrate compared to a standard “high” sputtering temperature. For purposes of illustration of the effect of substrate temperature on coloration efficiency, FIG. 2 depicts a coloration efficiency curve associated with one example of a reduced-temperature “warm” substrate (e.g., about 150° C.) for comparison to a coloration efficiency curve associated with one example of a high-temperature “hot” substrate (e.g., about 280° C.).

The SEM image depicted at the top of FIG. 3 (identified as “Substrate Temperature(3)”) corresponds to a WOₓ layer formed at the example standard-temperature “hot” substrate (e.g., about 280° C.) as in FIG. 2. The SEM image depicted at the top of FIG. 3 illustrates an example of a “fully crystallized” WOₓ microstructure associated with a substrate temperature that is greater than a high temperature threshold. The SEM image depicted at the bottom of FIG. 3 (identified as “Substrate Temperature(1)”) corresponds to a WOₓ layer formed at the example reduced-temperature “warm” substrate (e.g., about 150° C.) as in FIG. 2. The SEM image depicted at the bottom of FIG. 3 illustrates an example of a “fully amorphous” WOₓ microstructure associated with a first moderate-temperature “warm” substrate temperature. Thus, as the WOₓ microstructure remains amorphous in this example, the first moderate-temperature “warm” substrate temperature is less than a low temperature threshold for partial crystallization. The SEM image depicted in the middle of FIG. 3 (identified as “Substrate Temperature(2)”) corresponds to a WOₓ layer formed at a moderate “warm” temperature that is a range of about 160° C. to about 190° C. The SEM image depicted in the middle of FIG. 3 illustrates an example of a change of WOₓ micro-structure from the “fully amorphous” WOₓ microstructure to a “partially crystallized in amorphous matrix” WOₓ microstructure.

In some cases, a process of forming an electrochromic stack that includes reducing the substrate temperature during sputtering of the WOₓ EC layer may result in degradation of transmission efficiency of the electrochromic stack. To illustrate, a process of forming an electrochromic stack that includes sputtering of a WOₓ EC layer at a standard “hot” temperature may result in the electrochromic stack having a transmission efficiency of 1 percent or less. Without other process modifications, forming the WOₓ EC layer at the reduced substrate temperature may degrade the transmission efficiency to about 7 to 8 percent. As illustrative, non-limiting examples, to compensate for such a degradation of transmission efficiency associated with the reduced-temperature sputtering of the WOₓ EC layer and achieve a transmission efficiency of 1 percent or less, modifications to the standard process of forming the electrochromic stack may include: depositing a thicker WOₓ EC layer, thickening a CE layer (see e.g., the CE layer 212 of FIG. 1), adjusting amount(s) of sputtered lithium (see e.g., the Li1 layer 206 and/or the Li2 layer 210 of FIG. 1), adjusting mobile Li in the stack, or a combination thereof, among other alternatives. To illustrate, a standard process of forming the electrochromic stack depicted on the right side of FIG. 1 may include forming the EC layer 204 having a thickness within a range of about 400 nm to about 550 nm. In one illustrative, non-limiting embodiment, for a process that utilizes the reduced substrate temperature, the EC layer 204 may be about 520 nm (or slightly less), and a thickness of the CE layer 212 (e.g., NiWOₓ) may be about 360 nm (approximately 40 percent more than a thickness of the CE layer 212 for the standard WOₓ EC layer hot-substrate sputtering process). As another example, for a standard hot-substrate WOₓ EC layer sputtering process, an amount of mobile Li in the electrochromic stack depicted on the right side of FIG. 1 may be about 30 mC. In one illustrative, non-limiting embodiment, for a process that utilizes the reduced substrate temperature, the amount of mobile Li in the stack may be increased from the standard 30 mC to about 35 mC. As yet another illustrative, non-limiting example, compared to a standard hot-substrate WOₓ EC layer sputtering process, the amount of sputtered Li in the electrochromic stack depicted on the right side of FIG. 1 (e.g., in the Li1 layer(s) 206, 210 and/or the Li2 layer 213) may be increased by roughly 20 to 30 percent.

Thus, FIGS. 2 and 3 illustrate the first approach of the present disclosure, according to some embodiments. FIG. 2 illustrates examples of the impact of a reduced substrate temperature during sputtering of a WOₓ EC layer on coloration efficiency. FIG. 3 depicts examples of SEM images to illustrate three different WOₓ microstructures associated with three different substrate temperatures during sputtering. The inventors have discovered that by finely tuning the substrate temperature during sputtering of a WOₓ EC layer, the WOₓ microstructure may be changed which leads to a changed color in the dark state (e.g., more grey and less blue).

As noted above, an EC layer may be formed over a substrate according to one or more process parameters that may specify a composition of deposition material to achieve a color target (e.g., a neutral or grey color). FIGS. 4 to 8 illustrate experimental data associated with the second approach of the present disclosure that generally involves utilizing a mixed M:W target to form a doped EC layer. The inventors collected experimental data for EC layers formed using various mixed M:W targets at various temperatures. At standard deposition temperature, the inventors discovered that: Mo doping increases the charge capacity and maximum contrast but does not significantly neutralize the dark state; Nb doping decreases charge capacity slightly and efficiently neutralizes the dark state; and V doping strongly neutralizes the dark state but significantly decreases the contrast. At reduced deposition temperature, the inventors discovered that: Mo doping decreases the contrast and strongly neutralizes the dark state; and Nb doping decreases charge capacity and contrast (though still considered satisfactory) and slightly neutralizes the dark state (compared to WOx deposited at the same temperature). Although not bound by theory, the inventors believe that, in the case of Nb doping and lower temperature deposition, the amorphization of the WOx appears to be responsible for neutralization of the dark state. In the case of Mo and V doping, the inventors believe that the insertion of the dopant inside the WOx lattice leads to a change of optical gap.

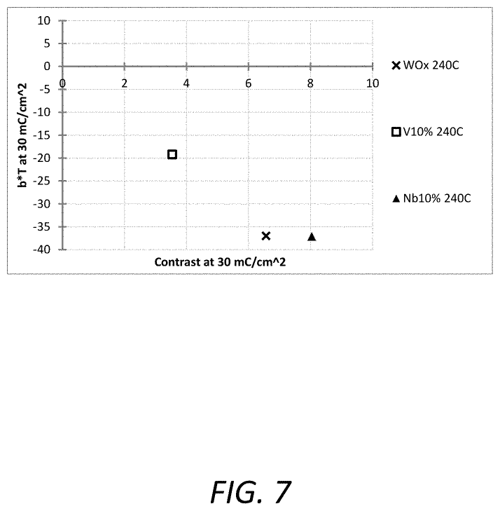

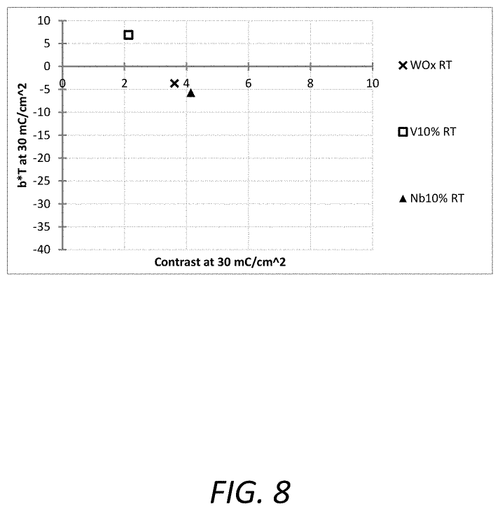

FIGS. 4 to 8 are graphs depicting additional details regarding the second approach of the present disclosure (identified by the reference character 106″ in FIG. 1), which generally involves utilizing a mixed metallic M:W target to introduce dopant(s) into the sputter-deposited WOₓ EC layer. FIGS. 4 to 6 are graphs depicting experimental data associated with the use of various custom-manufactured mixed M:W targets to form a “doped” EC layer, using a first coater associated with a first production line. FIGS. 7 and 8 are graphs depicting experimental data associated with the use of various co-sintered M:W targets to form a “doped” EC layer, using a second coater associated with a second production line.

Referring to FIG. 4, a graph depicts values of b*T (Y-axis) and contrast (X-axis) at 30 mC/cm² for an EC layer formed using various targets at a sputtering temperature of 240° C. In FIG. 4, the graph depicts the b*T and contrast measurements in which the sputtered EC layer is formed from: a mixed Mo:W target (having a 10 wt % Mo dopant concentration); a first mixed Nb:W target (having a 5 wt % Nb dopant concentration); a second mixed Nb:W target (having a 10 wt % Nb dopant concentration); and a standard undoped W target (for purposes of comparison to the mixed M:W targets).

For reference purposes, evaluation of an EC layer formed from a standard undoped W target at a sputtering temperature of 240° C. yielded the following values at 30 mC/cm² (as depicted in FIG. 4): b*T=−37.7; contrast=6.6 (TLmax\TL, where TLmax=74.5 and TL=11.3). A standard amount of Li (equivalent to about 1 μg/cm²) was sputtered to form a Li1 layer overlying the EC layer.

As a first comparative example, evaluation of an EC layer formed from a first mixed Nb:W target (5 wt % Nb) at a sputtering temperature of 240° C. yielded the following values at 30 mC/cm² (as depicted in FIG. 4): b*T=−29.3; contrast=6.4 (TLmax\TL, where TLmax=79.8 and TL=12.5). An amount of Li (equivalent to about 1 μg/cm²) was sputtered to form a Li1 layer overlying the EC layer.

As a second comparative example, evaluation of an EC layer formed from a second mixed Nb:W target (10 wt % Nb) at a sputtering temperature of 240° C. yielded the following values at 30 mC/cm² (as depicted in FIG. 4): b*T=−26.6; contrast=10.4 (TLmax\TL, where TLmax=78 and TL=10.3). An amount of Li (equivalent to about 1 μg/cm²) was sputtered to form a Li1 layer overlying the EC layer.

As a third comparative example, evaluation of an EC layer formed from a mixed Mo:W target (10 wt % Mo) at a sputtering temperature of 240° C. yielded the following values at 30 mC/cm² (as depicted in FIG. 4): b*T=−33.2; contrast=9.0 (TLmax\TL, where TLmax=72.1 and TL=8). An amount of Li (equivalent to about 1 μg/cm²) was sputtered to form a Li1 layer overlying the EC layer.

While not shown in FIG. 4, alternative amounts of sputtered Li were also investigated for an EC layer formed from the mixed Mo:W target, including: no sputtered Li; an amount of sputtered Li equivalent to about 0.2 μg/cm²; and an amount of sputtered Li equivalent to about 1.6 μg/cm².

In the case of no sputtered Li, evaluation of an EC layer formed from the mixed Mo:W target (10 wt % Mo) at a sputtering temperature of 240° C. yielded the following values at 30 mC/cm²: b*T=−32.7; contrast=10.1 (TLmax\TL, where TLmax=79.8 and TL=7.9).

In the case of an amount of sputtered Li equivalent to about 0.2 μg/cm², evaluation of an EC layer formed from the mixed Mo:W target (10 wt % Mo) at a sputtering temperature of 240° C. yielded the following values at 30 mC/cm²: b*T=−36.3; contrast=8.2 (TLmax\TL, where TLmax=80.7 and TL=9.8).

In the case of an amount of sputtered Li equivalent to about 1.6 μg/cm², evaluation of an EC layer formed from the mixed Mo:W target (10 wt % Mo) at a sputtering temperature of 240° C. yielded the following values at 30 mC/cm²: b*T=−33.1; contrast=8.5 (TLmax\TL, where TLmax=82 and TL=9.7).

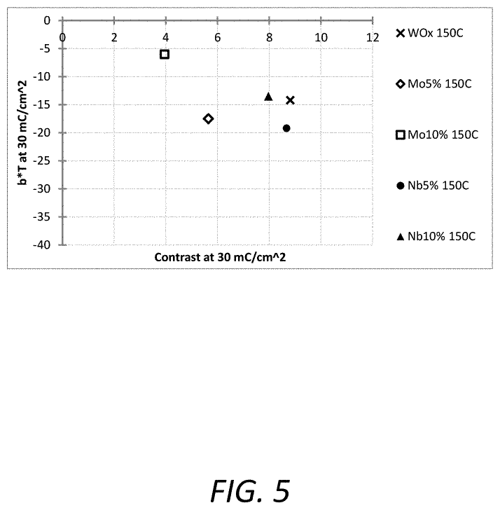

Referring to FIG. 5, a graph depicts values of b*T (Y-axis) and contrast (X-axis) at 30 mC/cm² for an EC layer formed using various targets at a reduced sputtering temperature of 150° C. In FIG. 5, the graph depicts the b*T and contrast measurements for an EC layer formed from: a first mixed Mo:W target (having a 5 wt % Mo dopant concentration); a second mixed Mo:W target (having a 10 wt % Mo dopant concentration); a first mixed Nb:W target (having a 5 wt % Nb dopant concentration); a second mixed Nb:W target (having a 10 wt % Nb dopant concentration); and a standard undoped W target (for purposes of comparison to the mixed M:W targets).

For reference purposes, evaluation of an EC layer formed from a standard undoped W target at a reduced sputtering temperature of 150° C. yielded the following values at 30 mC/cm² (as depicted in FIG. 5): b*T=<−14.2; contrast=8.8 (TLmax\TL, where TLmax=67 and TL=7.6). An amount of Li (equivalent to about 1 μg/cm²) was sputtered to form a Li1 layer overlying the EC layer.

As a first comparative example, evaluation of an EC layer formed from a first mixed Nb:W target (5 wt % Nb) at the reduced sputtering temperature of 150° C. yielded the following values at 30 mC/cm² (as depicted in FIG. 5): b*T=−19.2; contrast=8.7 (TLmax\TL, where TLmax=77.2 and TL=8.9). An amount of Li (equivalent to about 1 μg/cm²) was sputtered to form a Li1 layer overlying the EC layer.

While not shown in FIG. 5, an amount of sputtered Li equivalent to about 1.6 μg/cm² was also evaluated for the first mixed Nb:W target (5 wt % Nb). The evaluation yielded the following values at 30 mC/cm²: b*T=−24.2; contrast=9.1 (TLmax\TL, where TLmax=80.1 and TL=8.8).

As a second comparative example, evaluation of an EC layer formed from a second mixed Nb:W target (10 wt % Nb) at the reduced sputtering temperature of 150° C. yielded the following values at 30 mC/cm² (as depicted in FIG. 5): b*T=−13.5; contrast=8.0 (TLmax\TL, where TLmax=78.9 and TL=9.9). An amount of Li (equivalent to about 1 μg/cm²) was sputtered to form a Li1 layer overlying the EC layer.

While not shown in FIG. 5, an amount of sputtered Li equivalent to about 1.6 μg/cm² was also evaluated for the second mixed Nb:W target (10 wt % Nb). The evaluation yielded the following values at 30 mC/cm²: b*T=−20; contrast=8.7 (TLmax\TL, where TLmax=78.3 and TL=9).

As a third comparative example, evaluation of an EC layer formed from a first mixed Mo:W target (5 wt % Mo) at a reduced sputtering temperature of 150° C. yielded the following values at 30 mC/cm² (as depicted in FIG. 5): b*T=−17.5; contrast=5.6 (TLmax\TL, where TLmax=74 and TL=13.1). An amount of Li (equivalent to about 1 μg/cm²) was sputtered to form a Li1 layer overlying the EC layer.

While not shown in FIG. 5, an amount of sputtered Li equivalent to about 1.6 μg/cm² was also evaluated for the first mixed Mo:W target (10 wt % Nb). The evaluation yielded the following values at 30 mC/cm²: b*T=−17.6; contrast=6.0 (TLmax\TL, where TLmax=74.1 and TL=12.3).

As a fourth comparative example, evaluation of an EC layer formed from a second mixed Mo:W target (10 wt % Mo) at a reduced sputtering temperature of 150° C. yielded the following values at 30 mC/cm² (as depicted in FIG. 5): b*T=−6; contrast=3.9 (TLmax\TL, where TLmax=69.1 and TL=17.5). An amount of Li (equivalent to about 1 μg/cm²) was sputtered to form a Li1 layer overlying the EC layer.

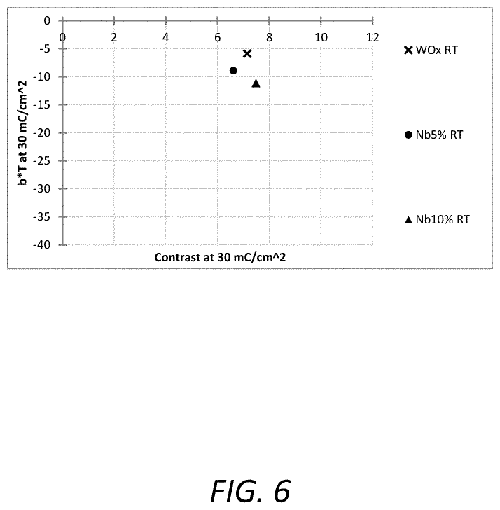

Referring to FIG. 6, a graph depicts values of b*T (Y-axis) and contrast (X-axis) at 30 mC/cm² for an EC layer deposited using various targets at room temperature. In FIG. 6, the graph depicts the b*T and contrast measurements in which the sputtered EC layer is formed from: a first mixed Nb:W target (having a 5 wt % Nb dopant concentration); a second mixed Nb:W target (having a 10 wt % Nb dopant concentration); and a standard undoped W target (for purposes of comparison to the mixed M:W targets).

For reference purposes, evaluation of an EC layer formed from a standard undoped W target at room temperature yielded the following values at 30 mC/cm² (as depicted in FIG. 6): b*T=<−5.9; contrast=7.2 (TLmax\TL, where TLmax=61.5 and TL=8.6). An amount of Li (equivalent to about 1 μg/cm²) was sputtered to form a Li1 layer overlying the EC layer.

As a first comparative example, evaluation of an EC layer formed from a first mixed Nb:W target (5 wt % Nb) at room temperature yielded the following values at 30 mC/cm² (as depicted in FIG. 6): b*T=−8.9; contrast=6.6 (TLmax\TL, where TLmax=77.2 and TL=11.7). An amount of Li (equivalent to about 1 μg/cm²) was sputtered to form a Li1 layer overlying the EC layer.

As a second comparative example, evaluation of an EC layer formed from a second mixed Nb:W target (10 wt % Nb) at room temperature yielded the following values at 30 mC/cm² (as depicted in FIG. 6): b*T=−11.1; contrast=7.5 (TLmax\TL, where TLmax=77.9 and TL=10.4). An amount of Li (equivalent to about 1 μg/cm²) was sputtered to form a Li1 layer overlying the EC layer.

While not shown in FIG. 6, an amount of sputtered Li equivalent to about 1.6 μg/cm² was also evaluated for the second mixed Nb:W target (10 wt % Nb). The evaluation yielded the following values at 30 mC/cm²: b*T=−12.9; contrast=6.3 (TLmax\TL, where TLmax=77 and TL=12.2).

Referring to FIG. 7, a graph depicts values of b*T (Y-axis) and contrast (X-axis) at 30 mC/cm² for an EC layer formed using various targets at a sputtering temperature of 240° C. (on a different production line than the one used for the examples depicted in FIGS. 4-6). In FIG. 7, the graph depicts the b*T and contrast measurements in which the sputtered EC layer is formed from: a co-sintered Nb:W target (having a 10 wt % Nb dopant concentration); a co-sintered V:W target (having a 10 wt % V dopant concentration); and a standard undoped W target (for purposes of comparison to the mixed M:W targets).

For reference purposes, evaluation of an EC layer was formed from a standard undoped W target at a sputtering temperature of 240° C. yielded the following values at 30 mC/cm² (as depicted in FIG. 7): b*T=−37; contrast=6.6 (TLmax\TL, where TLmax=85.3 and TL=13). An amount of Li (equivalent to 200 mm/min) was sputtered to form a Li1 layer overlying the EC layer.

As a first comparative example, evaluation of an EC layer formed from a mixed Nb:W target (10 wt % Nb) at a sputtering temperature of 240° C. yielded the following values at 30 mC/cm² (as depicted in FIG. 7): b*T=−37.1; contrast=8.0 (TLmax\TL, where TLmax=78.8 and TL=9.8). An amount of Li (equivalent to 264 mm/min) was sputtered to form a Li1 layer overlying the EC layer.

While not shown in FIG. 7, sputtering no Li was also investigated for an EC layer formed from the mixed Nb:W target. In the case of no sputtered Li, evaluation of an EC layer formed from the mixed Nb:W target (10 wt % Nb) at a sputtering temperature of 240° C. yielded the following values at 30 mC/cm²: b*T=−38; contrast=11.8 (TLmax\TL, where TLmax=>72 and TL=6.1).

As a second comparative example, evaluation of an EC layer formed from a mixed V:W target (10 wt % V) at a sputtering temperature of 240° C. yielded the following values at 30 mC/cm² (as depicted in FIG. 7): b*T=−19.2; contrast=3.5 (TLmax\TL, where TLmax=73.7 and TL=20.8). An amount of Li (equivalent to 200 mm/min) was sputtered to form a Li1 layer overlying the EC layer.

Referring to FIG. 8, a graph depicts values of b*T (Y-axis) and contrast (X-axis) at 30 mC/cm² for an EC layer deposited using various targets at room temperature. In FIG. 8, the graph depicts the b*T and contrast measurements for an EC layer formed from: a co-sintered Nb:W target (having a 10 wt % Nb dopant concentration); a co-sintered V:W target (having a 10 wt % V dopant concentration); and a standard undoped W target (for purposes of comparison to the mixed M:W targets).

For reference purposes, evaluation of an electrochromic stack in which the EC layer was formed from a standard undoped W target at room temperature yielded the following values at 30 mC/cm² (as depicted in FIG. 8): b*T=−3.7; contrast=3.6 (TLmax\TL, where TLmax=61.5 and TL=19.5). In this case, no Li was sputtered.

As a first comparative example, evaluation of an EC layer formed from a mixed Nb:W target (10 wt % Nb) at room temperature yielded the following values at 30 mC/cm² (as depicted in FIG. 8): b*T=−5.7; contrast=4.1 (TLmax\TL, where TLmax=80.8 and TL=19.5). In this case, no Li was sputtered.

While not shown in FIG. 8, alternative amounts of sputtered Li were also investigated for an EC layer formed from the mixed Nb:W target, including: an amount of sputtered Li equivalent to 90 mm/min; and an amount of sputtered Li equivalent to 61 mm/min.

In the case of an amount of sputtered Li equivalent to 90 mm/min, evaluation of an EC layer formed from the mixed Nb:W target (10 wt % Nb) at room temperature yielded the following values at 30 mC/cm²: b*T=−3; contrast=3.9 (TLmax\TL, where TLmax=85.1 and TL=22.1).

In the case of an amount of sputtered Li equivalent to 61 mm/min, evaluation of an EC layer formed from the mixed Nb:W target (10 wt % Nb) at room temperature yielded the following values at 30 mC/cm²: b*T=−0.8; contrast=3.6 (TLmax\TL, where TLmax=82.6 and TL=23.2).

As a second comparative example, evaluation of an EC layer formed from a mixed V:W target (10 wt % V) at room temperature yielded the following values at 30 mC/cm² (as depicted in FIG. 8): b*T=6.9; contrast=2.1 (TLmax\TL, where TLmax=73.2 and TL=34.4). In this case, no Li was sputtered.

Thus, FIGS. 4 to 8 illustrate experimental data collected for the second approach of the present disclosure, according to some embodiments. The inventors investigated various doped M:W targets for sputtering a doped EC layer (where M=Mo, Nb, or V). FIGS. 4 to 6 depict experimental data collected for various custom-manufactured mixed M:W targets at different sputtering temperatures using a first coater associated with a first production line. FIGS. 7 and 8 depict experimental data collected for various co-sintered M:W targets at different sputtering temperatures using a second coater associated with a second production line. The inventors have discovered that selected dopant concentrations in mixed M:W targets in combination with selected sputtering temperatures resulted in a changed color in the dark state (more neutral and less blue) compared to a standard WOₓ EC layer formed from an undoped W target. Specifically, for a mixed Mo:W target, a dopant concentration of Mo in the mixed Mo:W target may be in a range of about 2 to 20 weight percent, such as in a range of 5 to 10 weight percent. For a mixed Nb:W target, a dopant concentration of Nb in the mixed Nb:W target may be in a range of about 2 to 20 weight percent, such as in a range of 5 to 10 weight percent. For a mixed V:W target, a dopant concentration of V in the mixed V:W target may be in a range of about 2 to 20 weight percent, such as in a range of 5 to 10 weight percent.

As noted above, an EC layer may be formed over a substrate according to one or more process parameters that may specify deposition process parameters to achieve a color target (e.g., a neutral or grey color) in a dark state of a final EC stack including the EC layer. FIGS. 9 and 10 are graphs depicting experimental data associated with the third approach of the present disclosure, which generally involves adjusting a thickness of a sputter-deposited WOₓ EC layer. The third approach is also referred to herein as a “thin WOₓ approach” and may include modifying a standard EC layer deposition process (that produces a “standard” WOₓ EC layer thickness) in various ways to reduce the thickness of the sputter-deposited WOₓ EC layer.

With regard to the third approach, a process of forming an electrochromic device may include: providing a substrate; providing multiple tungsten (W) targets associated with multiple WOₓ deposition stations; and forming an EC layer over the substrate. Forming the EC layer includes selectively modifying a standard set of process parameters at one or more of the WOₓ deposition stations, with the modified process parameters resulting in reduced WOₓ thickness relative to the standard set of process parameters. In some embodiments, the reduced WOₓ thickness and a CE layer thickness are selected such that with 25 mC/cm² of mobile Lithium, an average coloration efficiency of WOₓ deposited to form the EC layer is less than the average coloration efficiency of the CE layer.

In FIGS. 9 and 10, the graphs depict experimental data associated with a “half-thickness” EC layer. It will be appreciated that the “half-thickness” approach represents one illustrative, non-limiting example of a reduction of thickness of the EC layer 204. Other reduced thicknesses are contemplated, with corresponding modifications to other layers of the stack determined according to a particular value for the reduced thickness of the EC layer 204 of the stack.

To illustrate, a standard production process may include a substrate (e.g., a glass substrate, such as the substrate 200 depicted on the right side of FIG. 1) passing through multiple WOₓ deposition stations. In some embodiments, reducing the thickness of the sputter-deposited WOₓ EC layer may involve refraining from sputtering at one or more of the WOₓ deposition stations. In alternative embodiments, reducing the thickness of the sputter-deposited WOₓ EC layer may involve reducing power at one or more of the WOₓ deposition stations to reduce a WOₓ deposition rate. As an illustrative, non-limiting example, a standard production process may include passing a substrate through four WOₓ deposition stations to form a sputter-deposited WOₓ EC layer having a “standard” thickness. In some embodiments, such a production process may be modified to refrain from sputtering at one, two, or three of the four WOx deposition stations to form a sputter-deposited WOₓ EC layer having a reduced thickness compared to the standard thickness. In alternative embodiments, such a production process may be modified to reduce power at one or more of the four WOₓ deposition stations to reduce the WOₓ deposition rate, resulting in the formation of a sputter-deposited WOₓ EC layer having a reduced thickness compared to the standard thickness.

The inventors have observed that, with the third approach, a coloration efficiency of a thin-WOₓ EC layer may decrease with increasing Li content. To illustrate, referring back to the right side of FIG. 1, migration of Li+ mobile ions from the Li1 layer 206 into the EC layer 204 (having the reduced WOₓ thickness) may result in the WOₓ of the EC layer 204 not coloring as much. As such, the third approach of the present disclosure may involve not only reducing a thickness of the sputter-deposited EC layer 204 but also reducing an amount of Li that is sputtered onto the EC layer 204 to form the Li1 layer 206. The third approach of the present disclosure may also involve changing a ratio of a thickness of the EC layer 204 to a thickness of the CE layer 212. The inventors have discovered that intentionally changing the ratio of the thicknesses of the EC layer 204 and the CE layer 212 provided the ability to modify the average coloration efficiency with fixed amount of charge in the WOₓ, leading to a changed color in the dark state. Although not bound by theory, a brown color of the CE layer 212 may have a tendency to dominate a blue color of the WOₓ of the EC layer 204, which may yield a more neutral coloration in the dark state. The inventors have also observed that product compromises associated with the third approach of the present disclosure may include: difficulty controlling exactly what color is achieved in the dark state (may be more grey-greenish); and controlling color change may be more challenging due to leakage current issues associated with Li in the WOₓ layer.

An example of the third approach of the present disclosure is described with respect to the example depicted on the right side of FIG. 1. In a standard production process, a thickness of WOₓ in the EC layer 204 may be in a range of about 400 nm to about 550 nm. In the case of a “half-thickness” approach, the thickness of the EC layer 204 may be reduced to a thickness value that is within a range of about 200 to 275 nm. As previously described herein, this may accomplished by utilizing a reduced number of WOₓ deposition stations for sputtering (e.g., 2 stations instead of 4 stations) or by reducing power at one or more of the WOₓ deposition stations to halve the WOₓ deposition rate. In the standard production process, a thickness of the CE layer 212 may be about 250 nm prior to lithiation to form the Li2 layer 213 and about 340 nm after the lithiation. To reduce the deleterious effect of excess Li on the coloration efficiency of the WOₓ in the reduced-thickness EC layer 204, the amount of Li sputtered onto the EC layer 204 to form the Li1 layer 206 may be reduced accordingly. To illustrate, in an example of a standard production process, an amount of Li sputtered onto the EC layer 204 to form the Li1 layer 206 equivalent to a range of 12 to 16 kW of Li1. In the third approach of the present disclosure, to lower the level of Li1 to match the storage capacity of the thinner WOₓ, a Li1 gradient of 11 to 17 kW may be utilized, according to some embodiments. Further, in the standard production process, an amount of mobile Li in the stack may be about 25 mC/cm², which may increase to about 47 mC/cm² for the “half-thickness” approach, according to some embodiments. In some embodiments, the process may include sputtering an increased amount of Li onto the IC layer 208 to form the Li1 layer 211 (prior to formation of the CE layer 212). Additionally, for the “half-thickness” approach, the standard thickness of the CE layer 212 (including the Li2 layer 213) may be increased from about 320 nm to about 640 nm.

Referring to FIG. 9, a graph depicts experimental data related to the third approach to achieving a more neutral color in a dark state, which generally involves forming a reduced-thickness WOₓ EC layer. In FIG. 9, the graph depicts coloration efficiency (cm²/mC, along Y-axis) versus charge (mC/cm², along X-axis) for a “half-thickness” EC layer.

Referring to FIG. 10, a graph illustrates experimental data for a reduced-thickness WOₓ EC layer approach, depicting a bleached/tinted curve for the reduced-thickness WOₓ EC layer approach in comparison to a bleached/tinted curve for a standard full-thickness WOₓ EC layer approach. The graph depicted in FIG. 10 provides the switching color pattern for a “standard” full-thickness WOₓ EC layer and for a reduced half-thickness WOₓ EC layer from clear to tint. The color is measured at different voltages. Specifically, the optical properties were measured in the bleached state (−2V for 20 minutes) and in the tinted state (+3V for 30 minutes). FIG. 10 illustrates that, during the transition from clear to tint, b* returns to about 0 for the half-thickness WOₓ approach. By contrast, b* remains below −8 in the tinted state for the standard full-thickness WOₓ approach. FIG. 10 further illustrates that, in the tinted state, there is no significant change in a* for the standard-thickness WOₓ approach and the half-thickness WOₓ approach. Thus, compared to the standard-thickness WOₓ approach, the half-thickness WOₓ approach is more neutral (less blue) in the tinted state.

Embodiments of the present disclosure can be described in view of the following clauses:
Clause 1. A process of forming an electrochromic device, the process comprising:
providing a substrate;
providing a target for sputtering; and
forming an electrochromic (EC) layer over the substrate, wherein forming the EC layer includes maintaining the substrate at a temperature that is less than a high temperature threshold associated with formation of a crystallized WOₓ microstructure during sputtering of the target,
wherein a WOₓ microstructural change associated with maintaining the substrate at the temperature during the sputtering of the target results in a changed color in a dark state compared to the crystallized WOₓ microstructure.
Clause 2. The process of clause 1, wherein the EC layer has an amorphous WOₓ microstructure when the temperature is less than a low temperature threshold, and wherein the EC layer has a partially crystallized in amorphous matrix WOₓ microstructure when the temperature is greater than the low temperature threshold.
Clause 3. The process of clause 1, wherein the temperature is less than 200° C.
Clause 4. The process of clause 1, wherein the temperature is in a range of 100° C. to 200° C.
Clause 5. The process of clause 1, wherein the temperature is in a range of 150° C. to 200° C.
Clause 6. The process of clause 1, wherein the temperature is in a range of 160° C. to 190° C.
Clause 7. A process of forming an electrochromic device, the process comprising:
providing a substrate;
providing a mixed metallic target for sputtering, the mixed metallic target including tungsten (W) and a dopant (M), wherein M corresponds to niobium (Nb), molybdenum (Mo), or vanadium (V); and
forming a doped electrochromic (EC) layer over the substrate, wherein forming the doped EC layer includes sputtering the mixed metallic target,
wherein utilizing the mixed M:W target for sputtering results in a changed color in a dark state compared to a WOₓ EC layer formed by sputtering a W target.
Clause 8. The process of clause 7, wherein the mixed metallic target is a mixed Mo:W target, and wherein forming the doped EC layer includes heating of the substrate during sputtering of the mixed Mo:W target such that a temperature of the substrate is within a temperature range associated with the changed color in the dark state.
Clause 9. The process of clause 7, wherein the mixed metallic target is a mixed Mo:W target, and wherein a dopant concentration of Mo in the mixed Mo:W target is in a range of about 2 to 20 weight percent.
Clause 10. The process of clause 7, wherein the mixed metallic target is a mixed Nb:W target, and wherein forming the doped EC layer includes heating of the substrate during sputtering of the mixed Nb:W target such that a temperature of the substrate is within a temperature range associated with the changed color in the dark state.
Clause 11. The process of clause 7, wherein the mixed metallic target is a mixed Nb:W target, and wherein a dopant concentration of Nb in the mixed Nb:W target is in a range of about 2 to 20 weight percent.
Clause 12. The process of clause 7, wherein the mixed metallic target is a mixed V:W target, and wherein forming the doped EC layer includes heating of the substrate during sputtering of the mixed V:W target such that a temperature of the substrate is within a temperature range associated with the changed color in the dark state.
Clause 13. The process of clause 7, wherein the mixed metallic target is a mixed V:W target, and wherein a dopant concentration of V in the mixed V:W target is in a range of about 2 to 20 weight percent.
Clause 14. A process of forming an electrochromic device, the process comprising:
providing a substrate;
providing multiple tungsten (W) targets associated with multiple WOₓ deposition stations; and
forming an electrochromic (EC) layer over the substrate, wherein forming the EC layer includes selectively modifying a standard set of process parameters at one or more of the WOₓ deposition stations, the modified process parameters resulting in reduced WOₓ thickness relative to the standard set of process parameters,
wherein the reduced WOₓ thickness and a counter-electrode (CE) layer thickness are selected such that with 25 mC/cm² of mobile Lithium, an average coloration efficiency of WOₓ deposited to form the EC layer is less than the average coloration efficiency of the CE layer.
Clause 15. The process of clause 14, wherein the modified process parameters include refraining from sputtering of one or more W targets at one or more of the WOₓ deposition stations.
Clause 16. The process of clause 15, wherein the multiple WOₓ deposition stations include four WOₓ deposition stations, the modified process parameters including refraining from sputtering two of four W targets such that the reduced WOₓ thickness is half of the standard WOₓ thickness.
Clause 17. The process of clause 14, wherein selectively modifying the standard set of process parameters includes reducing power at one or more of the WOₓ deposition stations to reduce a WOₓ deposition rate.
Clause 18. The process of clause 14, further comprising:
forming a first lithium (Li1) layer over the EC layer, wherein forming the Li1 layer includes selectively modifying a standard set of metallic lithium (Li) sputtering process parameters to reduce an amount of sputter-deposited metallic Li.
Clause 19. The process of clause 14, wherein the EC layer has a first coloration efficiency and a counter-electrode (CE) layer of the electrochromic device has a second coloration efficiency, the process further comprising modifying a ratio of thicknesses the EC layer and the CE layer to modify an average coloration efficiency associated with a combination of the first coloration efficiency and the second coloration efficiency.
Clause 20. The process of clause 14, further comprising:
forming a second lithium (Li2) layer over a counter-electrode (CE) layer of the electrochromic device, wherein forming the Li2 layer includes selectively modifying a standard set of metallic lithium (Li) sputtering process parameters to increase an amount of sputter-deposited metallic Li.
Clause 21. An electrochromic stack, comprising:
a substrate; and
an electrochromic (EC) layer overlying the substrate, the EC layer having an amorphous WOx microstructure or a partially crystallized in amorphous matrix WOₓ microstructure,
wherein the EC layer has a different color in a dark state compared to a WOₓ EC layer having a crystallized WOₓ microstructure.
Clause 22. An electrochromic device, comprising:
an electrochromic stack, the electrochromic stack comprising:
a substrate; and
an electrochromic (EC) layer overlying the substrate, the EC layer having an amorphous WOx microstructure or a partially crystallized in amorphous matrix WOₓ microstructure,
wherein the EC layer has a different color in a dark state compared to a WOₓ EC layer having a crystallized WOₓ microstructure.
Clause 23. An electrochromic stack, comprising:
a substrate; and
a doped electrochromic (EC) layer overlying the substrate, the doped EC layer including a doped tungsten oxide (MWOₓ) material, wherein M is a dopant corresponding to niobium (Nb), molybdenum (Mo), or vanadium (V),
wherein the dopant results in a different color in a dark state compared to an undoped WOₓ EC layer.

Clause 24. The electrochromic stack of clause 23, wherein a concentration of the dopant in the doped EC layer is in a range of about 2 to 20 weight percent.
Clause 25. An electrochromic device, comprising:
an electrochromic stack, the electrochromic stack comprising:
a substrate; and
a doped electrochromic (EC) layer overlying the substrate, the doped EC layer including a doped tungsten oxide (MWOx) material, wherein M is a dopant corresponding to niobium (Nb), molybdenum (Mo), or vanadium (V),
wherein the dopant results in a different color in a dark state compared to an undoped WOₓ EC layer.
Clause 26. The electrochromic device of clause 25, wherein a concentration of the dopant in the doped EC layer of the electrochromic stack is in a range of about 2 to 20 weight percent.
Clause 27. An electrochromic stack, comprising:
a substrate;
an electrochromic (EC) layer overlying the substrate, the EC layer having a first coloration efficiency and having a reduced EC layer thickness that is less than a standard EC layer thickness that is at least 400 nm;
an ion-conducting (IC) layer overlying the EC layer; and
a counter-electrode (CE) layer overlying the IC layer, the CE layer having a second coloration efficiency and having an increased CE layer thickness that is greater than a standard CE layer thickness that is at least 320 nm,
wherein the reduced EC layer thickness and the increased CE layer thickness are selected such that with 25 mC/cm² of mobile Lithium, an average coloration efficiency of WOₓ in the EC layer is less than the average coloration efficiency of the CE layer.
Clause 28. An electrochromic device, comprising:
an electrochromic stack, the electrochromic stack comprising:
a substrate;
an electrochromic (EC) layer overlying the substrate, the EC layer having a first coloration efficiency and having a reduced EC layer thickness that is less than a standard EC layer thickness that is at least 400 nm;
an ion-conducting (IC) layer overlying the EC layer; and
a counter-electrode (CE) layer overlying the IC layer, the CE layer having a second coloration efficiency and having an increased CE layer thickness that is greater than a standard CE layer thickness that is at least 320 nm,
wherein the reduced EC layer thickness and the increased CE layer thickness are selected such that with 25 mC/cm2 of mobile Lithium, an average coloration efficiency of WOₓ in the EC layer is less than the average coloration efficiency of the CE layer.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

1.-14. (canceled)

15. An electrochromic stack, comprising:
a plurality of layers comprising one or more of:
an electrochromic (EC) layer overlying a substrate, the EC layer having an amorphous WOₓ microstructure or a partially crystallized in amorphous matrix WOₓ microstructure, wherein the EC layer has a different color in a dark state compared to a WOₓ EC layer having a crystallized WOₓ microstructure;
a doped EC layer overlying the substrate, the doped EC layer including a doped tungsten oxide (MWOₓ) material, wherein M is a dopant corresponding to niobium (Nb), molybdenum (Mo), or vanadium (V), wherein the dopant results in a different color in a dark state of the electrochromic stack compared to an undoped WOₓ EC layer; or
an EC layer overlying the substrate and a counter-electrode (CE) layer, wherein the EC layer has a reduced EC layer thickness that is less than a standard EC layer thickness of at least 400 nm, wherein the CE layer has an increased CE layer thickness greater than a standard CE layer thickness of at least 320 nm, and wherein the reduced EC layer thickness and the increased CE layer thickness are selected such that with 25 mC/cm² of mobile Lithium, an average coloration efficiency of WOₓ in the EC layer is less than an average coloration efficiency of the CE layer.

16. The electrochromic stack of claim 15, wherein a concentration of the dopant in the EC layer is in a range of about 2 to 20 weight percent.

17. The electrochromic stack of claim 15, further comprising:
an ion-conducting (IC) layer, wherein the IC layer overlies the EC layer and wherein the CE layer overlies the IC layer.

18. An electrochromic device, comprising:
an electrochromic stack, the electrochromic stack comprising:
a substrate; and
one or more of:
an electrochromic (EC) layer overlying the substrate, the EC layer having an amorphous WOₓ microstructure or a partially crystallized in amorphous matrix WOₓ microstructure, wherein the EC layer has a different color in a dark state compared to a WOₓ EC layer having a crystallized WOₓ microstructure;
a doped EC layer overlying the substrate, the doped EC layer including a doped tungsten oxide (MWOₓ) material, wherein M is a dopant corresponding to niobium (Nb), molybdenum (Mo), or vanadium (V), wherein the dopant results in a different color in a dark state of the electrochromic stack compared to an undoped WOₓ EC layer; or
an EC layer overlying the substrate and a counter-electrode (CE) layer, wherein the EC layer has a reduced EC layer thickness that is less than a standard EC layer thickness of at least 400 nm, wherein the CE layer has an increased CE layer thickness greater than a standard CE layer thickness of at least 320 nm, and wherein the reduced EC layer thickness and the increased CE layer thickness are selected such that with 25 mC/cm² of mobile Lithium, an average coloration efficiency of WOₓ in the EC layer is less than an average coloration efficiency of the CE layer.

19. The electrochromic device of claim 18, wherein a concentration of the dopant in the EC layer is in a range of about 2 to 20 weight percent.

20. The electrochromic device of claim 18, wherein the electrochromic stack further comprises:
an ion-conducting (IC) layer, wherein the IC layer overlies the EC layer and wherein the CE layer overlies the IC layer.
